(19) United States
(12) Patent Application Publication
(10) Pub. No.: US 2025/0173804 A1
(43) Pub. Date: May 29, 2025

(54) STUDENT STATUS ENGINE

(71) Applicant: FUSEMACHINES, INC., New York, NY (US)

(72) Inventors: Pramesh Gautam, Kathmandu (NP); Roshani Acharya, Kathmandu (NP); Roshan Gurung, Kathmandu (NP); Rakesh Kumar Katuwal, Kathmandu (NP); Sameer Maskey, New York, NY (US)

(21) Appl. No.: 18/732,238

(22) Filed: Jun. 3, 2024

Related U.S. Application Data
(60) Provisional application No. 63/470,330, filed on Jun. 1, 2023.

(51) Int. Cl. G06Q 50/20

(52) U.S. Cl. CPC G06Q 50/205

(57) ABSTRACT

The present disclosure provides a student progression tracking system in which a data collection module collects the training data from the education network and sends it to a storage network for a training module to create a machine learning model to track the status of students performance in a course and the training module sends the machine learning model to an inference module which selects the data for each student in each course and inputs the data into the machine learning model and stores the students status for the course.

### CROSS-REFERENCE TO RELATED APPLICATIONS

The present patent application claims the priority benefit of U.S. provisional patent application 63/470,330 filed Jun. 1, 2023, the disclosure of which is incorporated herein by reference.

### BACKGROUND OF THE DISCLOSURE

### 1. Field of the Disclosure

The present disclosure is generally related to a system for assessing learning progress of different students within online courses.

### 2. Description of the Related Art

Currently, it is difficult for teachers, instructors, professors to track the performance status of each individual student (e.g., how much each student has learned of the course material) in each class or course the teacher instructs. Also, teachers collect mass amounts of test and quiz performance data for each student to determine their grades, but besides progress reports or report cards, a teachers do not have the insight to determine how a specific student is performing on a day to day basis. Lastly, it is often challenging for a teacher to identify the courses in which a student is struggling until the student is already behind in the class in terms of learning the material and once this is noticed it may be too late or be very challenging for the student to catch up. Thus, there is a need in the prior art to provide a student status engine to track the learning progress of each student.

### BRIEF DESCRIPTIONS OF THE DRAWINGS

The present disclosure provides a student progression tracking system in which a data collection module collects the training data from the education network and sends it to a storage network for a training module to create a machine learning model to track the status of students performance in a course and the training module sends the machine learning model to an inference module which selects the data for each student in each course and inputs the data into the machine learning model and stores the students status for the course.

FIG. 1 illustrates an AI student status engine.

FIG. 2 illustrates an AI student status managing module.

FIG. 3 illustrates a data collection module.

FIG. 4 illustrates an inference module.

FIG. 5 illustrates a display module.

FIG. 6 illustrates a training module.

FIG. 7 illustrates an example of computing system.

FIG. 8 illustrates an example neural network architecture.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

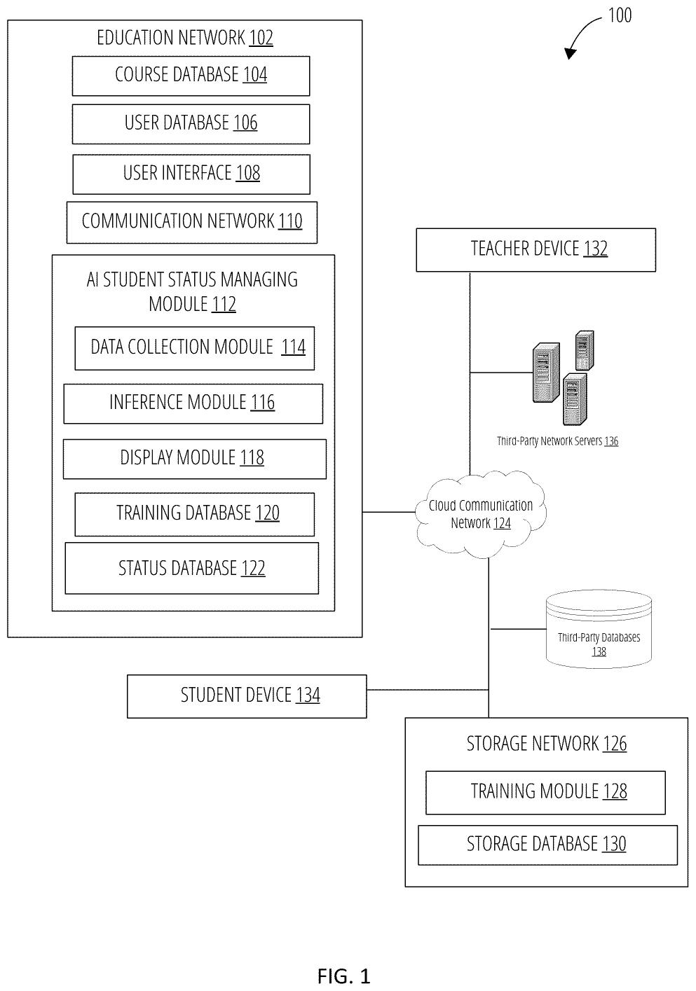

FIG. 1 illustrates a system providing an AI student status engine. This system comprises of an education network 102, allowing users to take one or more courses online. The education network 102 provides teachers, professors, instructors, etc. the ability to track the general progress of a student for a particular course. In some cases, the education network 102 may include a course database 104 that may store data related to courses available on the education network 102. Course information may include but is not limited to course titles, topics, syllabuses, resource materials, exams, quizzes, and instructors. In some cases, the education network 102 may include a user database 106 that may store data related to users of the education network 102. Users may include students, instructors, proctors, or administrators. User information may include contact information, device information, courses enrolled in, attendance, grades, etc.

In some cases, the education network 102 may include a user interface(s) 108 that may either accept inputs from users or provide outputs to the users or may perform both the actions. In some case, a user can interact with the user interface(s) 108 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the user interface(s) 108 may either be implemented as a Command Line Interface (CLI), a Graphical User Interface (GUI), a voice interface, or a web-based user-interface. In some cases, the education network 102 may include a comms 110 or communication network 110 which may be a wired and/or a wireless network. The communication network 110, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 110 may allow ubiquitous access to shared pools of configurable system resources and higher-level services that can be rapidly provisioned with minimal management effort, often over Internet and relies on sharing of resources to achieve coherence and economics of scale, like a public utility, while third-party clouds enable organizations to focus on their core businesses instead of expending resources on computer infrastructure and maintenance.

In some cases, the education network 102 may include an AI student status managing module 112 which may begin by initiating the data collection module 114. The AI student status managing module 112 may be continuously polling to receive the status predicting machine-learning model from the training module 128. The AI student status managing module 112 may receive the status predicting machine-learning model from the training module 128. The AI student status managing module 112 may send the status predicting machine-learning model to the inference module 116. The AI student status managing module 112 may initiate the inference module 116. The AI student status managing module 112 may initiate the display module 118.

In some cases, the education network 102 may include a data collection module 114 which may begin by being initiated by the AI student status managing module 112. The data collection module 114 may extract the data from the training database 120. The data collection module 114 may extract the features from the extracted data from the training database 120. The data collection module 114 may connect to the training module 128. The data collection module 114 may send the extracted features to the training module 128. The data collection module 114 may return to the AI student status managing module 112.

In some cases, the education network 102 may include an inference module 116 which may begin by being initiated by the AI student status managing module 112. The inference module 116 may receive the status predicting machine-learning model from the AI student status managing module 112. The inference module 116 may filter the course database 104 on the first student ID. The inference module 116 may filter the course database 104 on the first course ID. The inference module 116 may extract the filtered data from the course database 104 and may extract the features from the extracted filtered data from the course database 104. The inference module 116 may initiate the status predicting machine-learning model. The inference module 116 may store the student status in the status database 122. The inference module 116 determines if there are more course remaining for the student.

If it is determined that there are more courses remaining for the student the inference module 116 filters the course database 104 on the next course ID and the process returns to extracting the data from the filtered course database 104. If it is determined that there are no more courses remaining for the student the inference module 116 determines if there are more students remaining, If it is determined that there are more students remaining the inference module 116 filters the course database 104 on the next student ID and the process returns to filtering the course database 104 on the course ID. If it is determined that there are no more students remaining in the course database 104 the inference module 116 returns to the AI student status managing module 112.

In some cases, the education network 102 may include a display module 118 which may begin by being initiated by the AI student status managing module 112. The display module 118 may extract the data from the status database 122. The display module 118 may display the student statuses on the user interface 108. The display module 118 may return to the AI student status managing module 112.

In some cases, the education network 102 may include a training database 120 which contains the training data that is used by the training module 128 to generate the status predicting machine-learning model to determine the status of the students. The training data may contain historical student's data that has been previously manually labeled by instructors or teachers. The data annotations stored in the database contain the label training data and the features that allows the status predicting machine-learning model to be generated by learning to recognize the features of the training data. Annotations may be performed by multiple human annotators to ensure that high levels of inter-annotator agreement is achieved. Inter-annotator or inter-rater agreement may be a quantitative measure of the degree to which multiple human annotators agree in their subjective labels of some stimulus data.

In some cases, the education network 102 may include a status database 122 which contains a list of the student's IDs, course IDs the student is currently enrolled in, and the status of the student for the course which may indicated by a green color, yellow color, or red color indicating if the student is performing well, average, or failing, respectively. The database may be accessed by the teacher to view the status of how each student is performing in each class and may be updated daily to provide the teacher with the most up to date data.

In some cases, the education network 102 may include a cloud 124 which is a distributed network of computers comprising servers and databases. A cloud 124 may be a private cloud 124, where access is restricted by isolating the network such as preventing external access, or by using encryption to limit access to only authorized users. Alternatively, a cloud 124 may be a public cloud 124 where access is widely available via the internet. A public cloud 124 may not be secured or may be include limited security features.

In some cases, the education network 102 may include a storage network 126 which may be a cloud computing model that enables storing data and files on the internet through a cloud computing provider that may be accessed either through the public internet or a dedicated private network connection. The storage network 126 may contain the training module 128, which is used to generate the status predicting machine-learning model used by the inference module 116 as well as store the extracted features from the training. In some cases, the education network 102 may include a training module 128 which begins by connecting to the education network 102. The training module 128 continuously polls to receive the features from the data collection module 114. The training module 128 receives the features from the data collection module 114. The training module 128 generates the status predicting machine-learning model. The training module 128 stores the features in the storage database 130. The training module 128 sends the status predicting machine-learning model to the AI student status managing module 112 and returns to continuously polling to receive the features from the data collection module 114.

In some cases, the education network 102 may include a storage database 130 which contains the features received from the training module 128 which may be used to for further training of the status predicting machine-learning model. In some embodiments, the features stored in the storage database 130 may be used during the process described in the inference module 116 to predict labels for the student's statuses. In some cases, the education network 102 may include a teacher device 124 that may be a computing device such as a personal computer, laptop, smartphone, tablet, or smart speaker. In some embodiments, the teacher may be able to login or access the education network 102 through the teacher device 124 to track the progress of each student through the user interface 108 provided by the education network 102.

In some cases, the education network 102 may include a student device 128 that may be a computing device such as a personal computer, laptop, smartphone, tablet, or smart speaker. In some embodiments, the students may be able to access the education network 102 through the student device 128 to complete assignments, take exams, review course materials, etc. In some embodiments, the student device 128 may include a camera integrated with or communicatively coupled with the student device 128. The camera captures video at 30 frames per second in one embodiment. In some embodiments, the student device 128 may include a microphone integrated with or communicatively coupled with the student device 128.

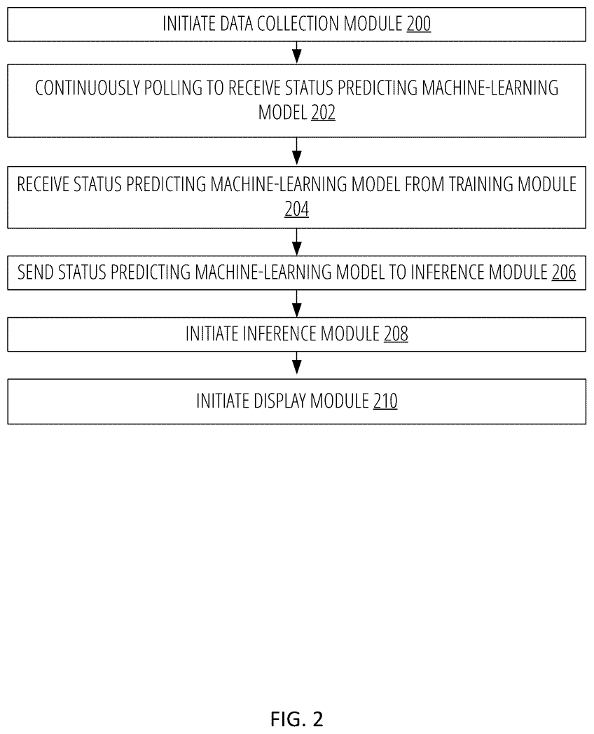

FIG. 2 illustrates the AI student status managing module 112. The process may begin with the AI student status managing module 112 initiating, at step 200, the data collection module 114. For example, the data collection module 114 may begin by being initiated by the AI student status managing module 112. In some cases, the data collection module 114 is initiated based on a request, for one or more statuses for one or more students of one or more online courses of a plurality of online courses of one or more online course providers of a plurality of online course providers in the student progression tracking system.

The data collection module 114 may extract the data from the training database 120. The data collection module 114 may extract the features from the extracted data from the training database 120. The data collection module 114 may connect to the training module 128. The data collection module 114 sends the extracted features to the training module 128. The data collection module 114 returns to the AI student status managing module 112.

The AI student status managing module 112 may be continuously polling, at step 202, to receive the status predicting machine-learning model from the training module 128. For example, the AI student status managing module 112 may be continuously polling to receive the status predicting machine-learning model from the training module 128 which may be generated by the training module 128 to predict a student's status for a particular course by analyzing the student's data as it is stored on the education network 102, such as assignment scores, quiz scores, completed projects and assignments, activity on the education network 102, etc., to provide the teacher with an indicator to instantly recognize the student's performance and progression. In some embodiments, the version of the status predicting machine-learning model that is received by the education network 102 may be for a particular school, education facility, university, etc.

The AI student status managing module 112 may receive, at step 204, the status predicting machine-learning model from the training module 128. For example, the AI student status managing module 112 may receive the status predicting machine-learning model from the training module 128 and may be generated to predict a student's status for a particular course by analyzing the student's data as it is stored on the education network 102, such as assignment scores, quiz scores, completed projects and assignments, activity on the education network 102, etc. The student's status may be provided to the teacher with an indicator to instantly recognize the student's performance and progression.

In some embodiments, the version of the status predicting machine-learning model that is received by the education network 102 may be for a particular school, education facility, university, etc. The AI student status managing module 112 sends, at step 206, the status predicting machine-learning model to the inference module 116. For example, the AI student status managing module 112 sends the status predicting machine-learning model that is received from the training module 128 to the inference module 116 which may be generated by the training module 128 to predict a student's status for a particular course by analyzing the student's data as it is stored on the education network 102, such as assignment scores, quiz scores, completed projects and assignments, activity on the education network 102, etc., to provide the teacher with an indicator to instantly recognize the student's performance and progression. In some embodiments, the version of the status predicting machine-learning model that is received by the education network 102 may be for a particular school, education facility, university, etc.

The AI student status managing module 112 may initiate, at step 208, the inference module 116. For example, the inference module 116 may begin by being initiated by the AI student status managing module 112. The inference module 116 may receive the status predicting machine-learning model from the AI student status managing module 112. The inference module 116 may filter for coursework progression data with associated metadata matching with respective student IDs of the one or more students and respective course IDs of the one or more online courses. In some cases, the inference module 116 may filter the course database 104 on the first student ID and may also filter the course database 104 on the first course ID. The inference module 116 may extract the filtered data from the course database 104 and may extract the features from the extracted filtered data from the course database 104. The inference module 116 may initiate the status predicting machine-learning model.

The inference module 116 may store the student status in the status database 122. The inference module 116 determines if there are more course remaining for the student. If it is determined that there are more courses remaining for the student, the inference module 116 may filter the course database 104 on the next course ID and the process returns to extracting the data from the filtered course database 104. If it is determined that there are no more courses remaining for the student the inference module 116 determines if there are more students remaining, If it is determined that there are more students remaining the inference module 116 filters the course database 104 on the next student ID and the process returns to filtering the course database 104 on the course ID. If it is determined that there are no more students remaining in the course database 104 the inference module 116 returns to the AI student status managing module 112.

The AI student status managing module 112 may initiate, at step 210, the display module 118. For example, the display module 118 begins by being initiated by the AI student status managing module 112. The display module 118 extracts the data from the status database 122. The display module 118 displays the student statuses on the user interface 108. The display module 118 returns to the AI student status managing module 112.

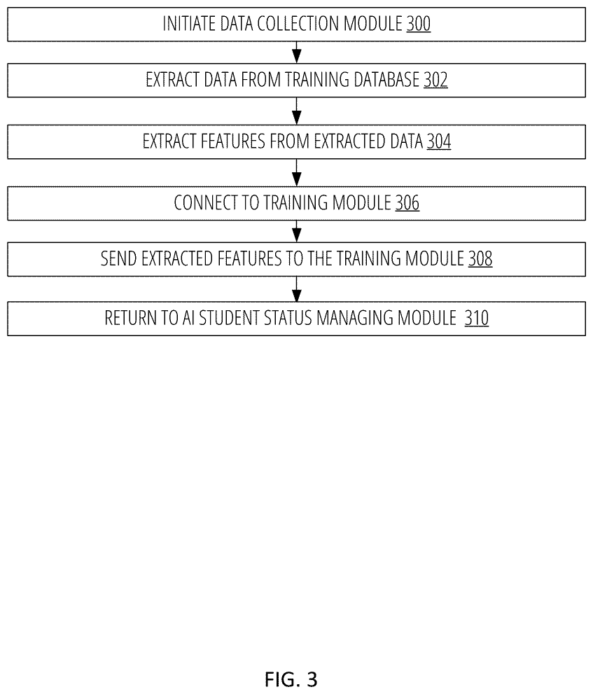

FIG. 3 illustrates the data collection module 114. The process may begin with the data collection module 114 being initiated, at step 300, by the AI student status managing module 112. In some embodiments, the data collection module may continuously be initiated to send the training data to the training module 128. In some embodiments, the data collection module 114 may query the training database 120 for new data and once new data is stored in the training database 120, the data collection module 114 may extract the training data and the features and may send the extracted features to the training module 128 to generate the status predicting machine-learning model. The data collection module 114 may extract, at step 302, the data from the training database 120. For example, the data collection module 114 may extract the training data that is needed by the training module 128 to generate the status predicting machine-learning model.

The data collection module 114 may extract, at step 304, the features from the extracted data from the training database 120. For example, the data collection module 114 may extract the features from the extracted training data from the training database 128. For example, the extracted features may be the student's total attendance in percentage for a particular course, total number of days the student has been engaged on the platform over a predetermined time period divided by the number of days in the interval, for example the number of days a student has been engaged on the platform over the past four weeks divided by the number of days, 28, in the interval, the total number of days elapsed since the student's last activity on the platform divided by the number of days elapsed since the courses start date, total videos watched divided by the total videos to be completed according to the lesson and adding through a weighted calculation for videos not in the lesson plan, there may be a weight given to videos according to a percent of students who completed the video for videos not completed in the lesson plan, total quizzes to be completed minus total quizzes completed divided by total quizzes to be completed plus adding a weighted difference of quiz not in the lesson plan, total assignments to be completed minus total assignments completed divided by total assignments to be completed plus adding a weighted difference of assignments not in lesson plan, total projects to be completed minus total projects completed divided by total projects to be completed plus adding a weighted difference of projects not in lesson plan, average of weighted scores obtained for quizzes completed in the lesson plan plus adding the average score obtained for quizzes not in lesson plan, average of weighted scores obtained for assignments completed in the lesson plan plus adding the average score obtained for assignments not in lesson plan, average of weighted scores obtained for projects completed in the lesson plan plus adding the average score obtained for projects not in lesson plan, etc.

In some embodiments, the lesson plan may include resources that have been identified as completed by the teacher. The data collection module 114 may connect, at step 306, to the training module 128. For example, the data collection module 114 may connect to the training module 128 on the storage network 126 through the communication network 110. The data collection module 114 may send, at step 308, the extracted features to the training module 128. For example, the data collection may send the extracted features to the training module 128.

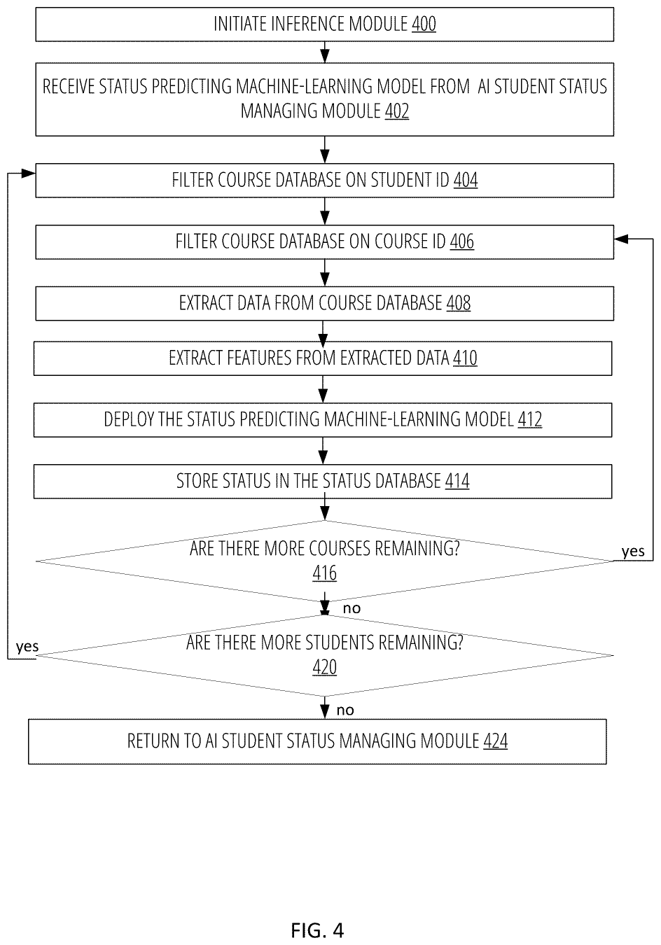

FIG. 4 illustrates the inference module 116. The process may begin with the inference module 116 being initiated, at step 400, by the AI student status managing module 112. For example, the inference module 116 may be initiated once the AI student status managing module 112 sends the status predicting machine-learning model to the inference module 116. The inference module 116 may receive, at step 402, the status predicting machine-learning model from the AI student status managing module 112. For example, the inference module 116 may receive the status predicting machine-learning model from the AI student status managing module 112, such as a model that is generated may predict a student's status for a particular course by analyzing the student's data as it is stored on the education network 102, such as assignment scores, quiz scores, completed projects and assignments, activity on the education network 102, etc., to provide the teacher with an indicator to instantly recognize the student's performance and progression.

In some embodiments, the version of the status predicting machine-learning model that is received by the inference module 116 may be for a particular school, education facility, university, etc. The inference module 116 may filter, at step 404, the course database 104 on the first student ID. For example, the inference module 116 may filter the course database 104 on the first student ID to filter the database on the student's courses and associated data, such as attendance, assignments, projects, quizzes, activity on the education network 102, etc. The inference module 116 may filter, at step 406, the course database 104 on the first course ID. For example, the inference module 116 then filters the course database 104 on the first course ID for the student to filter the database on the student's data, such as attendance, assignments, projects, quizzes, activity on the education network 102, etc., for that particular course.

The inference module 116 may extract, at step 408, the filtered data from the course database 104. For example, the inference module 116 extracts the student's data for the particular course from the filtered course database 104, such as attendance, assignments, projects, quizzes, activity on the education network 102, etc. The inference module 116 extracts, at step 410, the features from the extracted filtered data from the course database 104. For example, the inference module 116 extracts the features from the extracted filtered data from the course database 104, such as the student's total attendance in percentage for a particular course, total number of days the student has been engaged on the platform over a predetermined time period divided by the number of days in the interval, for example the number of days a student has been engaged on the platform over the past four weeks divided by the number of days, 28, in the interval, the total number of days elapsed since the student's last activity on the platform divided by the number of days elapsed since the courses start date, total videos watched divided by the total videos to be completed according to the lesson and adding through a weighted calculation for videos not in the lesson plan, there may be a weight given to videos according to a percent of students who completed the video for videos not completed in the lesson plan, total quizzes to be completed minus total quizzes completed divided by total quizzes to be completed plus adding a weighted difference of quiz not in the lesson plan, total assignments to be completed minus total assignments completed divided by total assignments to be completed plus adding a weighted difference of assignments not in lesson plan, total projects to be completed minus total projects completed divided by total projects to be completed plus adding a weighted difference of projects not in lesson plan, average of weighted scores obtained for quizzes completed in the lesson plan plus adding the average score obtained for quizzes not in lesson plan, average of weighted scores obtained for assignments completed in the lesson plan plus adding the average score obtained for assignments not in lesson plan, average of weighted scores obtained for projects completed in the lesson plan plus adding the average score obtained for projects not in lesson plan, etc. In some embodiments, the lesson plan may include resources that have been identified as completed by the teacher.

The inference module 116 deploys, at step 412, the status predicting machine-learning model. For example, the student's course data is run through the status predicting machine-learning model to determine the student's current status in the particular course. For example, the status predicting machine-learning model may be a machine learning model which may examine features, measurable properties, and parameters of a data set, such as the student's course data. It may utilize a feature vector, or a set of multiple numeric features, as a training input for prediction purposes. An algorithm takes a set of data known as “training data” as input. The learning algorithm finds patterns in the input data and trains the model for expected results. The output of the training process is the machine learning model. A model may then make a prediction when fed input data. The value that the machine learning model has to predict is called the target or label.

The status predicting machine-learning model may use a process of inference, such as a process of running data points into a machine learning model to calculate an output such as a single numerical score for each one of the features. In some embodiments, the features may be weighted to determine the status of the student, for example, student's attendance, quiz scores, and assignment scores may account more for a student's status than videos watched or activity on the education network 102. In some embodiments, the status predicting machine-learning model may be a rules based model in which the machine learning method identifies, learns, or evolves rules that are stored, manipulated or applied. Rules based machine learning identify and utilize a set of relational rules that represent the knowledge captured by the system. For example, the machine learning model may determine a set of rules in which the students grades for assignments, projects, exams, etc. are compared to in order to generate a status for the student. In some embodiments, the status predicting machine-learning model may be a generated by a neural network which may be trained by processing examples that contain a known input, such as the student's data, and a known result, such as the student's status, forming probability weighted associations between the input and result. The training may be supervised training in which the difference between the prediction and the target output is determined and weighted associations are adjusted until the prediction is similar to the target output. For example, the neural network may be trained on the data stored in the training database 120 to generate the status predicting machine-learning model and when the student's data, such as assignment scores, project score, exam scores, etc. are inputted the status predicting machine-learning model may output a student's status in the course.

In some embodiments, the status predicting machine-learning model may be an adaptive model in which artificial intelligence algorithms are used to deliver customized resources and learning activities to address the unique needs of the learner. For example, the status predicting machine-learning model may be able to predict the student's status and provide resources to the student to improve their status on the courses they are performing poorly or below average in. In some embodiments, the status predicting machine-learning model may include a knowledge graph model in which a graph structured data is used to integrate the new data, such as the student's data. Knowledge graphs store interlinked descriptions of objects, events, situations, or abstract concepts, and encodes the semantics underlying the terminology used. For example, the training data stored in the training database 120 may be used to generate a knowledge graph model by linking the historical student's assignment scores, project scores, exam grades, etc. to a certain status and then when the new student's data is inputted into the status predicting machine-learning model the output would be the new student's status.

In some embodiments, the status predicting machine-learning model may perform a sentiment analysis, such as identifying and categorizing opinions expressed in a piece of text to determine the writer's attitude towards a particular topic. For example, sentiment analysis may be performed if the students are required to submit an evaluation or survey of a particular course or lesson. In some embodiments, the status predicting machine-learning model may perform image recognition, such as the process of identifying an object or feature in an image. For example, image recognition may be performed on a student's assignment, project, exam, etc. to determine if the student is using a mathematical equation correctly, such as using the correct formula to find an answer.

In some embodiments, the status predicting machine-learning model may perform anomaly detection, such as identifying rare items, events, observations, etc. that deviate from the majority of the data and do not conform to well defined notion of normal. For example, anomaly detection may be performed on the student's assignments, projects, exams, etc. to determine if there is an anomaly in the student's submission compared to other work completed by the student in order to determine if the student is cheating, plagiarizing, etc.

In some embodiments, the status predicting machine-learning model may perform predictive modeling, such as utilizing statistics to predict outcomes. For example, predictive modeling may be used to determine if a student will fail a particular course based on their current submissions allowing the teacher or professor to provide the student with additional resources to improve their scores in the particular course. In some embodiments, the status predicting machine-learning model may perform natural language processing, such as the ability of a computer to understand human language as it is spoken and written. For example, natural language processing may be used to convert a student's presentation that is uploaded to the education network 102 from speech to text allowing for the presentation to be inputted into the education network 102 in a text format. In some embodiments, the status predicting machine-learning model may perform time series forecasting, such as analyzing time series data using statistics and modeling to make predictions and inform strategic decision making. For example, time series forecasting may be used to analyze the performance of all the students in a particular course to determine the status of all the students which may lead to the teacher or professor providing additional resources or adjusting the lesson plan if many of the students are falling behind or not performing as expected.

The inference module 116 may store, at step 414, the student status in the status database 122. For example, the status predicting machine-learning model may generate a status for the student in the particular course, such as performing well, average, or failing, and store the data in the status database 122. In some embodiments, a visual indicator may be stored in the status database 122 to represent the student's status in the particular course to allow the teacher to easily identify the student's status, for example, green may indicate the student is performing well, yellow may indicate the student is performing average, and red may indicate the student is failing.

The inference module 116 may determine, at step 416, if there are more course remaining for the student. For example, the inference module 116 determines if the student has had all of their courses and the resulting data run through the status predicting machine-learning model. If it is determined that there are more courses remaining for the student the inference module 116 filters, at step 418, the course database 104 on the next course ID and the process returns to extracting the data from the filtered course database 104. For example, the next course ID in the course database 104 is selected and the course database 104 is filtered on the course ID to filter the database on the student's data for the particular course.

If it is determined that there are no more courses remaining for the student the inference module 116 may determine, at step 420, if there are more students remaining. For example, the inference module 116 continuously loops the process until all of the students and the data associated with each one of their courses is given a status through the status predicting machine-learning model for the teacher to be able the current status of all the students and the current courses they are enrolled in. If it is determined that there are more students remaining the inference module 116 filters, at step 422, the course database 104 on the next student ID and the process returns to filtering the course database 104 on the course ID. For example, the inference module 116 filters the course database 104 on the next student ID and the process returns to filtering the course database 104 on each of the student's courses until the status predicting machine-learning model is performed on all of the data associated with each one of the student's courses. If it is determined that there are no more students remaining in the course database 104 the inference module 116 returns, at step 424, to the AI student status managing module 112.

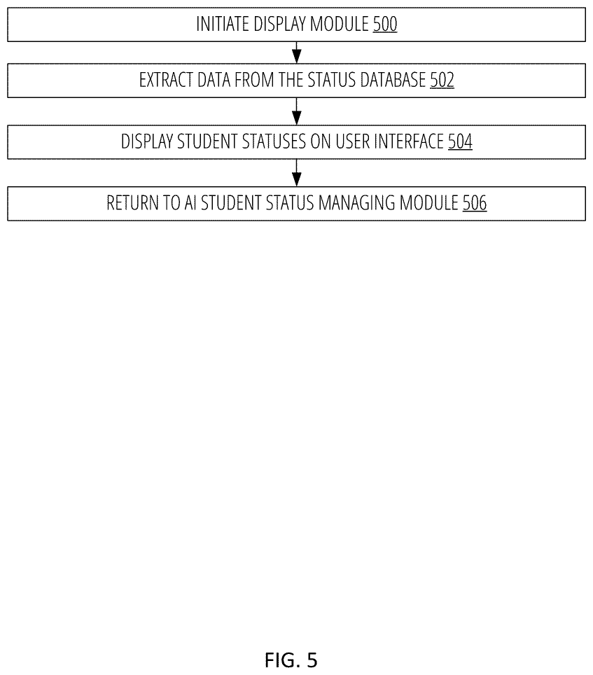

FIG. 5 illustrates the display module 118. The process begins with the display module 118 being initiated, at step 500, by the AI student status managing module 112. In some embodiments, the display module 118 may be initiated once the status database 122 receives a new entry. For example, the display module 118 may query the status database 122 for a new data entry, extract the entry including the visual indicator and display the student's status on the user interface 108. The display module 118 extracts, at step 502, the data from the status database 122. For example, the display module 118 extracts the data from the student database 122, such as the student's IDs, course IDs the student is currently enrolled in, and the status of the student for the course which may indicated by a green color, yellow color, or red color indicating if the student is performing well, average, or failing, respectively.

The database may be accessed by the teacher to view the status of how each student is performing in each class and may be updated daily to provide the teacher with the most up to date data. The display module 118 displays, at step 504, the student statuses on the user interface 108. For example, the display module 118 may display the student statuses on the user interface 108 to inform the teacher, instructor, professor, etc. the student's status for a particular course. In some embodiments, the interface may display a list of all the students and their current statuses for a particular course and the teacher may be able to select different courses to allow the teacher to review the statuses of all of the students for all their courses. The display module 118 returns, at step 506, to the AI student status managing module 112.

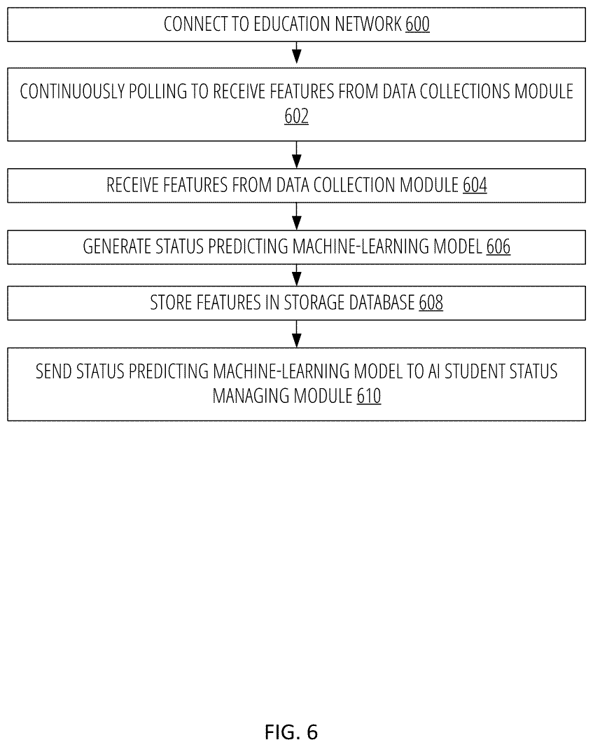

FIG. 6 illustrates the training module 128. The process begins with the training module 128 may connect, at step 600, to the education network 102. For example, the training module 128 may connect to the education network 102 through the communication network 110. The training module 128 may continuously poll, at step 602, to receive the features from the data collection module 114. For example, the training module 128 is continuously polling to receive the extracted features from the training data from the data collection module 114. In some embodiments, the training module 120 may be continuously polling to receive the training data from the data collection module 114.

The training module 128 may receive, at step 604, the features from the data collection module 114. For example, the training module 128 receives the extracted features from the training data from the data collection module 114. For example, the training module 128 may receive extracted features such as the student's total attendance in percentage for a particular course, total number of days the student has been engaged on the platform over a predetermined time period divided by the number of days in the interval, for example the number of days a student has been engaged on the platform over the past four weeks divided by the number of days, 28, in the interval, the total number of days elapsed since the student's last activity on the platform divided by the number of days elapsed since the courses start date, total videos watched divided by the total videos to be completed according to the lesson and adding through a weighted calculation for videos not in the lesson plan, there may be a weight given to videos according to a percent of students who completed the video for videos not completed in the lesson plan, total quizzes to be completed minus total quizzes completed divided by total quizzes to be completed plus adding a weighted difference of quiz not in the lesson plan, total assignments to be completed minus total assignments completed divided by total assignments to be completed plus adding a weighted difference of assignments not in lesson plan, total projects to be completed minus total projects completed divided by total projects to be completed plus adding a weighted difference of projects not in lesson plan, average of weighted scores obtained for quizzes completed in the lesson plan plus adding the average score obtained for quizzes not in lesson plan, average of weighted scores obtained for assignments completed in the lesson plan plus adding the average score obtained for assignments not in lesson plan, average of weighted scores obtained for projects completed in the lesson plan plus adding the average score obtained for projects not in lesson plan, etc.

In some embodiments, the lesson plan may include resources that have been identified as completed by the teacher. The training module 128 generates, at step 606, the status predicting machine-learning model. For example, the training module 128 uses the features extracted from the training data to generate a status predicting machine-learning model, which may be a machine learning model. For example, the status predicting machine-learning model may be a machine learning model which may examine features, measurable properties, and parameters of a data set. It may utilize a feature vector, or a set of multiple numeric features, as a training input for prediction purposes. An algorithm takes a set of data known as “training data” as input. The learning algorithm finds patterns in the input data and trains the model for expected results.

The output of the training process may be the machine learning model. A model may then make a prediction when fed input data. The value that the machine learning model has to predict is called the target or label. For example, if the education network 102 can only provide limited training data cross validation may be used. For example, cross validation is a resampling procedure used to evaluate machine learning models on a limited data sample. The procedure has a single parameter called k that refers to the number of groups that a given data sample is to be split into. Cross-validation is a resampling method that uses different portions of the data to test and train a model on different iterations. It is mainly used in settings where the goal is prediction, and one wants to estimate how accurately a predictive model will perform in practice.

In a prediction problem, a model is usually given a dataset of known data on which training is run, such as the training data accounting for 80% of the total data set, and a dataset of unknown data, such as test data accounting for 20% of the total data set, against which the model is tested. The goal of cross-validation is to test the model's ability to predict new data that was not used in estimating it, in order to flag problems like overfitting or selection bias and to give an insight on how the model will generalize to an independent dataset. In some embodiments, the education network 102 may receive additional training data from teachers since they are able to label their students data, such as the extracted coursework progression data with their respective statuses, on the education network 102. In some embodiments, the newly added training data may add new features to input into the status predicting machine-learning model based on the labeled extracted coursework progression data.

In some embodiments, the newly added training data may be used to improve and enhance the status predicting machine-learning model prediction capabilities by retraining the model. In some embodiments, there may be different status predicting machine-learning models used for different schools, education facility, universities, etc. The status predicting machine-learning model that is generated may predict a student's status for a particular course by analyzing the student's data as it is stored on the education network 102, such as assignment scores, quiz scores, completed projects and assignments, activity on the education network 102, etc., to provide the teacher with an indicator to instantly recognize the student's performance and progression.

In some embodiments, the status predicting machine-learning model may be a rules based model in which the machine learning method identifies, learns, or evolves rules that are stored, manipulated or applied. Rules based machine learning identify and utilize a set of relational rules that represent the knowledge captured by the system. For example, the machine learning model may determine a set of rules in which the students grades for assignments, projects, exams, etc. are compared to in order to generate a status for the student. In some embodiments, the status predicting machine-learning model may be a generated by a neural network which may be trained by processing examples that contain a known input, such as the student's data, and a known result, such as the student's status, forming probability weighted associations between the input and result. The training may be supervised training in which the difference between the prediction and the target output is determined and weighted associations are adjusted until the prediction is similar to the target output. For example, the neural network may be trained on the data stored in the training database 120 to generate the status predicting machine-learning model and when the student's data, such as assignment scores, project score, exam scores, etc. are inputted the status predicting machine-learning model may output a student's status in the course.

In some embodiments, the status predicting machine-learning model may be an adaptive model in which artificial intelligence algorithms are used to deliver customized resources and learning activities to address the unique needs of the learner. For example, the status predicting machine-learning model may be able to predict the student's status and provide resources to the student to improve their status on the courses they are performing poorly or below average in. In some embodiments, the status predicting machine-learning model may be a knowledge graph model in which a graph structured data is used to integrate the new data, such as the student's data. Knowledge graphs store interlinked descriptions of objects, events, situations, or abstract concepts, and encodes the semantics underlying the terminology used. For example, the training data stored in the training database 120 may be used to generate a knowledge graph model by linking the historical student's assignment scores, project scores, exam grades, etc. to a certain status and then when the new student's data is inputted into the status predicting machine-learning model the output would be the new student's status.

The training module 128 may store, at step 608, the features in the storage database 130. For example, the training module 128 stores the received extracted features used to generate the status predicting machine-learning model in the storage database 130, such as the student's total attendance in percentage for a particular course, total number of days the student has been engaged on the platform over a predetermined time period divided by the number of days in the interval, for example the number of days a student has been engaged on the platform over the past four weeks divided by the number of days, 28, in the interval, the total number of days elapsed since the student's last activity on the platform divided by the number of days elapsed since the courses start date, total videos watched divided by the total videos to be completed according to the lesson and adding through a weighted calculation for videos not in the lesson plan, there may be a weight given to videos according to a percent of students who completed the video for videos not completed in the lesson plan, total quizzes to be completed minus total quizzes completed divided by total quizzes to be completed plus adding a weighted difference of quiz not in the lesson plan, total assignments to be completed minus total assignments completed divided by total assignments to be completed plus adding a weighted difference of assignments not in lesson plan, total projects to be completed minus total projects completed divided by total projects to be completed plus adding a weighted difference of projects not in lesson plan, average of weighted scores obtained for quizzes completed in the lesson plan plus adding the average score obtained for quizzes not in lesson plan, average of weighted scores obtained for assignments completed in the lesson plan plus adding the average score obtained for assignments not in lesson plan, average of weighted scores obtained for projects completed in the lesson plan plus adding the average score obtained for projects not in lesson plan, etc. In some embodiments, the lesson plan may include resources that have been identified as completed by the teacher. In some embodiments, the status predicting machine-learning model may be a rules based model in which the machine learning method identifies, learns, or evolves rules that are stored, manipulated or applied.

Rules based machine learning identify and utilize a set of relational rules that represent the knowledge captured by the system. For example, the rules for the status predicting machine-learning model may be stored in the storage database 130 and when new training data becomes available the rules may be extracted and manipulated or adapted to the new data. In some embodiments, the status predicting machine-learning model may be a generated by a neural network which may be trained by processing examples that contain a known input, such as the student's data, and a known result, such as the student's status, forming probability weighted associations between the input and result. The training may be supervised training in which the difference between the prediction and the target output is determined and weighted associations are adjusted until the prediction is similar to the target output. For example, the training data may be stored in the storage database 130 and when new training data is available the status predicting machine-learning model may be trained on the combination of the new training data and the data stored in the storage database 130.

In some embodiments, the status predicting machine-learning model may be an adaptive model in which artificial intelligence algorithms are used to deliver customized resources and learning activities to address the unique needs of the learner. For example, the resources and activities provided to the student may be stored in the storage database 130 to determine the accuracy of the status predicting machine-learning model and used to further train the status predicting machine-learning model. In some embodiments, the status predicting machine-learning model may be a knowledge graph model in which a graph structured data is used to integrate the new data, such as the student's data. Knowledge graphs store interlinked descriptions of objects, events, situations, or abstract concepts, and encodes the semantics underlying the terminology used. For example, the training data used to generate the status predicting machine-learning model may be stored in the storage database 130 and when new training data becomes available the status predicting machine-learning model is trained on a combination of the new training data and the data stored in the storage database 130.

The training module 128 may send, at step 610, the status predicting machine-learning model to the AI student status managing module 112 and returns to continuously polling to receive the features from the data collection module 114. For example, the status predicting machine-learning model that is generated may predict a student's status for a particular course by analyzing the student's data as it is stored on the education network 102, such as assignment scores, quiz scores, completed projects and assignments, activity on the education network 102, etc., to provide the teacher with an indicator to instantly recognize the student's performance and progression. In some embodiments, the version of the status predicting machine-learning model that is sent to the education network 102 may be for a particular school, education facility, university, etc. functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

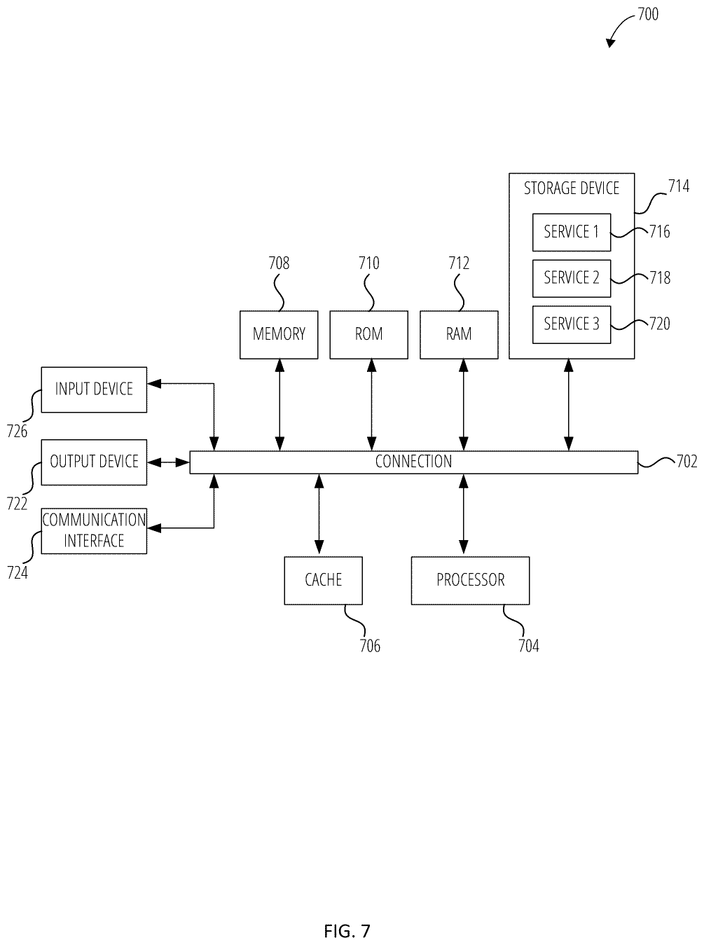

FIG. 7 shows an example of computing system 700, which can be for example any computing device making up education network 102, or any component thereof in which the components of the system are in communication with each other using connection 702. Connection 702 can be a physical connection via a bus, or a direct connection into processor 704, such as in a chipset architecture. Connection 702 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 700 includes at least one processing unit (CPU or processor) 704 and connection 702 that couples various system components including system memory 708, such as read-only memory (ROM) 710 and random access memory (RAM) 712 to processor 704. Computing system 700 can include a cache of high-speed memory 708 connected directly with, in close proximity to, or integrated as part of processor 704.

Processor 704 can include any general purpose processor and a hardware service or software service, such as services 706, 718, and 720 stored in storage device 714, configured to control processor 704 as well as a special-purpose processor where software instructions are incorporated into the actual processor design. Processor 704 may essentially be a completely self-contained computing system, containing multiple cores or processors, a bus, memory controller, cache, etc. A multi-core processor may be symmetric or asymmetric.

To enable user interaction, computing system 700 includes an input device 726, which can represent any number of input mechanisms, such as a microphone for speech, a touch-sensitive screen for gesture or graphical input, keyboard, mouse, motion input, speech, etc. Computing system 700 can also include output device 722, which can be one or more of a number of output mechanisms known to those of skill in the art. In some instances, multimodal systems can enable a user to provide multiple types of input/output to communicate with computing system 700. Computing system 700 can include communication interface 724, which can generally govern and manage the user input and system output. There is no restriction on operating on any particular hardware arrangement, and therefore the basic features here may easily be substituted for improved hardware or firmware arrangements as they are developed.

Storage device 714 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 714 can include software services, servers, services, etc., that when the code that defines such software is executed by the processor 704, it causes the system to perform a function. In some embodiments, a hardware service that performs a particular function can include the software component stored in a computer-readable medium in connection with the hardware components, such as processor 704, connection 702, output device 722, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

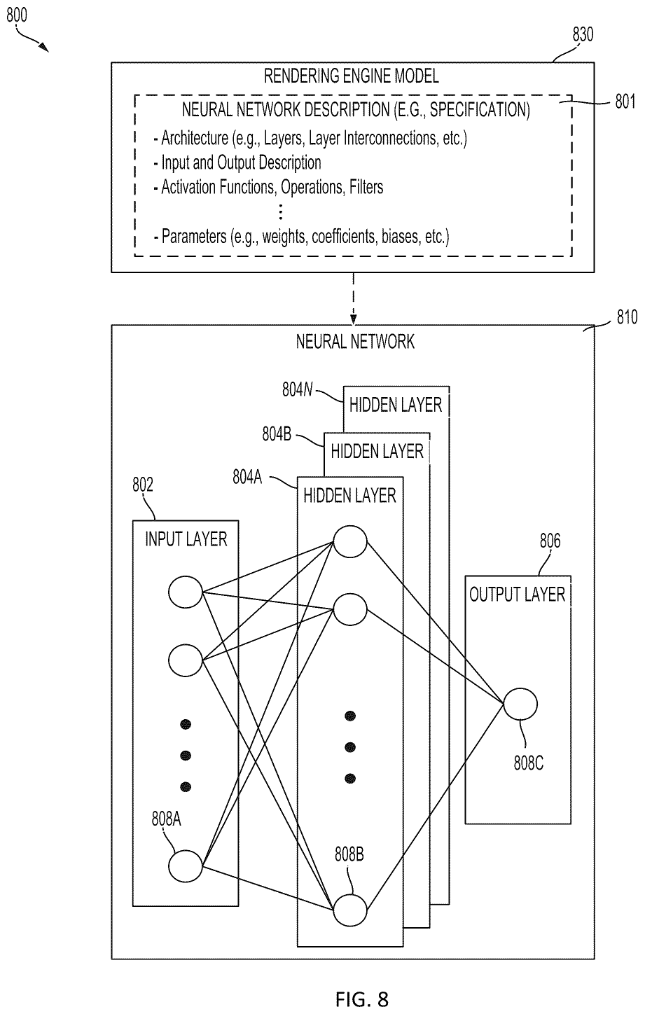

FIG. 8 illustrates an example neural network architecture. Architecture 800 includes a neural network 810 defined by an example neural network description 801 in rendering engine model (neural controller) 830. The neural network 810 can represent a neural network implementation of a rendering engine for rendering media data. The neural network description 801 can include a full specification of the neural network 810, including the neural network architecture 800. For example, the neural network description 801 can include a description or specification of the architecture 800 of the neural network 810 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 810 reflects the architecture 800 defined in the neural network description 801. In this example, the neural network 810 includes an input layer 802, which includes input data, such as extracted coursework progression data. In one illustrative example, the input layer 802 can include data representing a portion of the input media data such as a patch of data or pixels (e.g., extracted coursework progression data).

The neural network 810 includes hidden layers 804A through 804 N (collectively “804” hereinafter). The hidden layers 804 can include n number of hidden layers, where n is an integer greater than or equal to one. The number of hidden layers can include as many layers as needed for a desired processing outcome and/or rendering intent. The neural network 810 further includes an output layer 806 that provides an output (e.g., predicted status) resulting from the processing performed by the hidden layers 804. In one illustrative example, the output layer 806 can predict statuses.

The neural network 810 in this example is a multi-layer neural network of interconnected nodes. Each node can represent a piece of information. Information associated with the nodes is shared among the different layers and each layer retains information as information is processed. In some cases, the neural network 810 can include a feed-forward neural network, in which case there are no feedback connections where outputs of the neural network are fed back into itself. In other cases, the neural network 810 can include a recurrent neural network, which can have loops that allow information to be carried across nodes while reading in input.

Information can be exchanged between nodes through node-to-node interconnections between the various layers. Nodes of the input layer 802 can activate a set of nodes in the first hidden layer 804A. For example, as shown, each of the input nodes of the input layer 802 is connected to each of the nodes of the first hidden layer 804A. The nodes of the hidden layer 804A can transform the information of each input node by applying activation functions to the information. The information derived from the transformation can then be passed to and can activate the nodes of the next hidden layer (e.g., 804B), which can perform their own designated functions. Example functions include convolutional, up-sampling, data transformation, pooling, and/or any other suitable functions. The output of the hidden layer (e.g., 804B) can then activate nodes of the next hidden layer (e.g., 804 N), and so on. The output of the last hidden layer can activate one or more nodes of the output layer 806, at which point an output is provided. In some cases, while nodes (e.g., nodes 808A, 808B, 808C) in the neural network 810 are shown as having multiple output lines, a node has a single output and all lines shown as being output from a node represent the same output value.

In some cases, each node or interconnection between nodes can have a weight that is a set of parameters derived from training the neural network 810. For example, an interconnection between nodes can represent a piece of information learned about the interconnected nodes. The interconnection can have a numeric weight that can be tuned (e.g., based on a training dataset), allowing the neural network 810 to be adaptive to inputs and able to learn as more data is processed.

The neural network 810 can be pre-trained to process the features from the data in the input layer 802 using the different hidden layers 804 in order to provide the output through the output layer 806. In an example in which the neural network 810 is used to predict statuses, the neural network 810 can be trained using training data that includes historical coursework progression data and historical statuses. For instance, extracted coursework progression data can be input into the neural network 810, which can be processed by the neural network 810 to generate outputs which can be used to tune one or more aspects of the neural network 810, such as weights, biases, etc.

In some cases, the neural network 810 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 810, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 810 is unable to determine low level features and thus cannot make an accurate determination of what the classification of the object might be. A loss function can be used to analyze errors in the output. Any suitable loss function definition can be used.

The loss (or error) can be high for the first training dataset (e.g., extracted coursework progression data) since the actual values will be different than the predicted output. The goal of training is to minimize the amount of loss so that the predicted output comports with a target or ideal output. The neural network 810 can perform a backward pass by determining which inputs (weights) most contributed to the loss of the neural network 810, and can adjust the weights so that the loss decreases and is eventually minimized.

A derivative of the loss with respect to the weights can be computed to determine the weights that contributed most to the loss of the neural network 810. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 810 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 810 can represent any other neural or deep learning network, such as an autoencoder, a deep belief nets (DBNs), a recurrent neural networks (RNNs), etc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for predicting student coursework status, the method comprising;
storing coursework progression data in a course database in memory, wherein the coursework progression data includes metadata associated with coursework performance data of different students in one or more online courses;
filtering the coursework progression data based on a received request to identify a filtered set of coursework progression data;
predicting a status for one of the students associated with the received request based on use of a status predicting machine-learning model to analyze the filtered set of coursework progression data, wherein the status predicting machine-learning model has been trained in accordance with training data correlating a student status type to one or more coursework performance indicators; and
generating a display that presents the predicted status for each of the students associated with the received request.

2. The method of claim 1, wherein predicting the student status includes identifying a similarity between the filtered set coursework progression data and historical coursework progression data based on one or more rules weighted by the status predicting machine-learning model.

3. The method of claim 1, wherein the training data includes known historical coursework progression data inputs and known status outputs, and further comprising generating the status predicting machine-learning model by using a neural network to identify probability-weighted associations between the inputs and the outputs.

4. The method of claim 3, further comprising:
adapting the status predicting machine-learning model for the student; and
generating one or more customized learning activities accessible by a student device of the student.

5. The method of claim 4, wherein the learning activities are customized based on the predicted status of the student.

6. The method of claim 1, wherein the status predicting machine-learning model uses a knowledge graph that includes graph-structured data correlating one or more of historical assignment scores, project scores, and exam grades to a student status level.

7. The method of claim 1, further comprising adjusting one or more weights associated with one or more input features that include one or more of student attendance, quiz scores, assignment scores, course grades, and grade categories.

8. The method of claim 7, wherein the predicted status includes one or more likelihoods of failure of one of the online courses.

9. The method of claim 1, further comprising:
labeling the filtered set of coursework progression data based on feedback regarding the predicted status; and
retraining the status predicting machine-learning model based on the labeled set of coursework progression data.

10. A system for predicting student coursework status, the system comprising;
memory that stores coursework progression data in a course database, wherein the coursework progression data includes metadata associated with coursework performance data of different students in one or more online courses; and
one or more processors that execute instructions stored by a non-transitory computer-readable storage medium to:
filter the coursework progression data based on a received request to identify a filtered set of coursework progression data;
predict a status for one of the students associated with the received request based on use of a status predicting machine-learning model to analyze the filtered set of coursework progression data, wherein the status predicting machine-learning model has been trained in accordance with training data correlating a student status type to one or more coursework performance indicators; and
generate a display that presents the predicted status for each of the students associated with the received request.

11. The system of claim 10, wherein the processors predict the student status by identifying a similarity between the filtered set coursework progression data and historical coursework progression data based on one or more rules weighted by the status predicting machine-learning model.

12. The system of claim 10, wherein the training data includes known historical coursework progression data inputs and known status outputs, and wherein the processors execute further instructions to generate the status predicting machine-learning model by using a neural network to identify probability-weighted associations between the inputs and the outputs.

13. The system of claim 12, wherein the processors execute further instructions to:
adapt the status predicting machine-learning model for the student; and
generate one or more customized learning activities accessible by a student device of the student.

14. The system of claim 13, wherein the learning activities are customized based on the predicted status of the student.

15. The system of claim 10, wherein the status predicting machine-learning model uses a knowledge graph that includes graph-structured data correlating one or more of historical assignment scores, project scores, and exam grades to a student status level.

16. The system of claim 10, wherein the one or more processors execute further instructions to adjust one or more weights associated with one or more input features that include one or more of student attendance, quiz scores, assignment scores, course grades, and grade categories.

17. The system of claim 16, wherein the predicted status includes one or more likelihoods of failure of one of the online courses.

18. The system of claim 10, wherein the one or more processors execute further instructions to:
label the filtered set of coursework progression data based on feedback regarding the predicted status; and
retrain the status predicting machine-learning model based on the labeled set of coursework progression data.

19. A non-transitory computer-readable storage medium comprising instructions executable by a computing system to perform a method for predicting student coursework status, the method comprising:
storing coursework progression data in a course database in memory, wherein the coursework progression data includes metadata associated with coursework performance data of different students in one or more online courses;
filtering the coursework progression data based on a received request to identify a filtered set of coursework progression data;
predicting a status for one of the students associated with the received request based on use of a status predicting machine-learning model to analyze the filtered set of coursework progression data, wherein the status predicting machine-learning model has been trained in accordance with training data correlating a student status type to one or more coursework performance indicators; and
generating a display that presents the predicted status for each of the students associated with the received request.
